(19) United States
(12) Patent Application Publication
(10) Pub. No.: US 2002/0149204 A1
(43) Pub. Date: Oct. 17, 2002

(54) Air and water propulsion device-buoyancy motor

(76) Inventor: Michael Rauschenberger, Calgary (CA)

Correspondence Address: Mr. Michael Rauschenberger, 5024 Vantage Cresent N.W., Calgary, ALBERTA T3A 1X7, CA

(21) Appl. No.: 09/835,763

(22) Filed: Apr. 16, 2001

(51) Int. Cl. H02P 9/04

(52) U.S. Cl. 290/1 R

(57) ABSTRACT

This invention through the use of air, water and floaters will create a rotation to turn a shaft which can be used to propel gears, which in turn supplies the required energy to power generator(s). This device can provide different levels of output which would be determined by the number units added. This device is low in pollutants, noise, and maintenance.

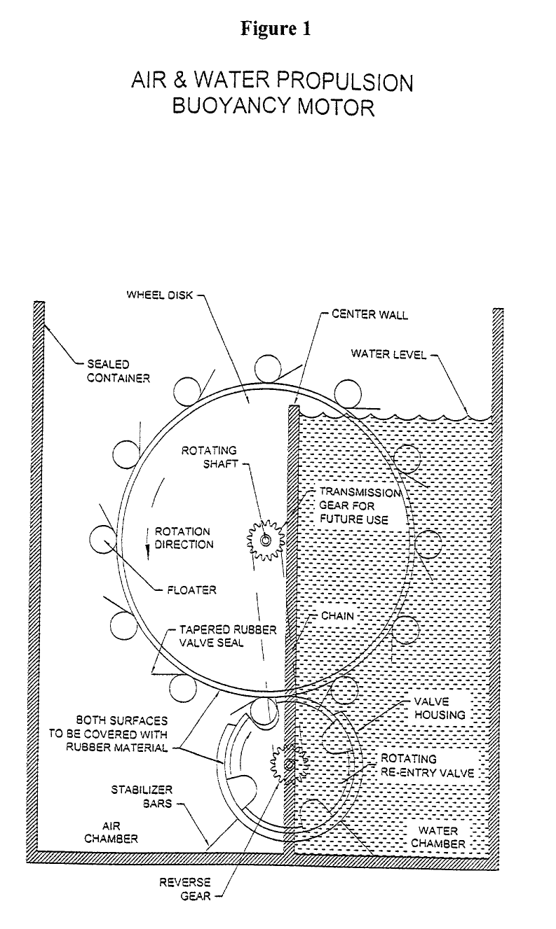

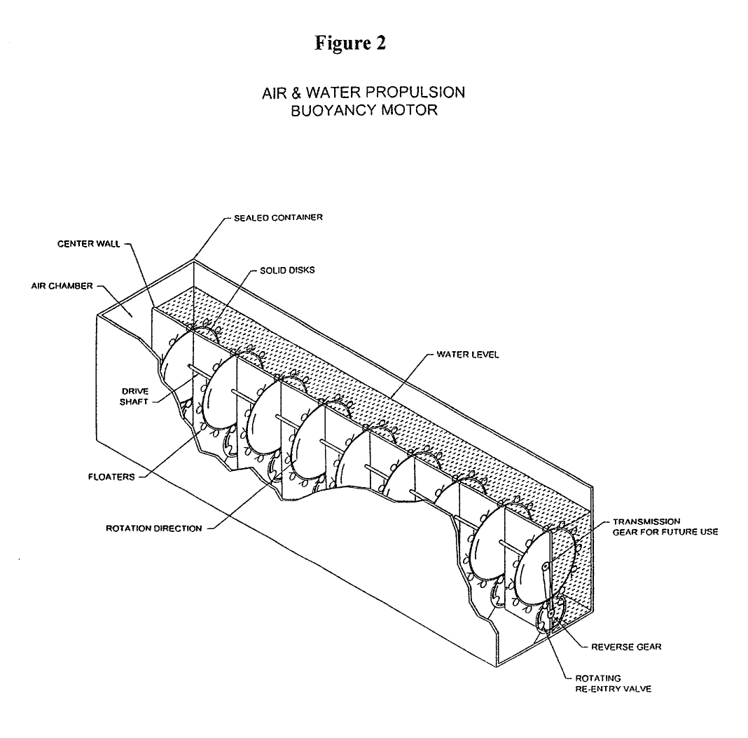

### FIG. 1-3

A tank which has two compartments, one for air and one for water. It is recommended that the tank be built with reinforced concrete to withstand pressure.

Solid wheel discs are used, with floaters of any shape or size which are attached to the outside of the wheels, which will turn and re-enter the lower portion of the water tank to produce energy

The discs can be enlarged to increase power or additional discs can be added to produce an unlimited source of power

It is essential to have spare discs to be installed for maintenance which can be engaged and disengaged without stopping the motor

The floaters enter the lower part of the water tank and create an upward thrust which turns the wheel and the drive shaft

The floaters must enter the water several degrees past the center of the shaft in order to create the upward thrust

The floaters must also enter the tank at staggered intervals to reduce the required power for re-entry

The gravity of the floaters in the air tank chamber, will assist the re-entry of the floaters

A variation of floatation devices can be used (e.g. cork, air, Styrofoam, and gases). It is recommended to use light weight materials in the construction of this device

The most important part of this invention is the revolving value shown in FIGS. 1, 2, and 3

Both surfaces of the wheel and the revolving valve must be covered with sponge-like rubber material for water proofing

The floaters shown in FIGS. 1, 2 and 3 have extensions built from solid rubber that is tapered at the ends. These extensions are designed to prolong the travel of the valve, preventing water from entering the floater chamber

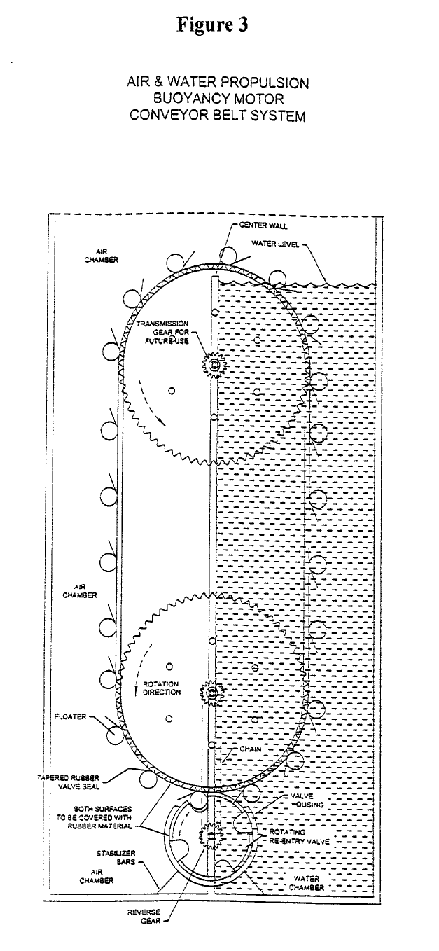

FIG. 3 works on the same principle as 1 and 2 with the difference being, it works on a chain or rubberized conveyor belt which the floaters are attached. A large amount of floaters can be used for greater power Large sprockets on top and bottom are needed to allow the floaters to re-enter the water. Re-entry of the floaters again must be water proof. This unit need less space but greater depth for a much longer travel of the floaters which creates more power

This device radiates a minimum amount of noise and is low maintenance if the units operate with the use of water as a liquid form. It is free of pollution.

1. The device creates a rotational motion using air, water, and a floatation system with re-entry into the water to create an upward thrust which in turn will produce energy.
